(19) United States
(12) Patent Application Publication
(10) Pub. No.: US 2002/0170072 A1
(43) Pub. Date: Nov. 14, 2002

(54) Systems for receiving and processing digital data carried by satellite transmissions

(76) Inventors: James A. Lundbald, Mountain View, CA (US); James A. Baldwin, Emerald Hills, CA (US); Louis F. Coffin, Mountain View, CA (US)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 09/851,841

(22) Filed: May 9, 2001

(51) Int. Cl. H04N 7/173; H04N 7/16

(52) U.S. Cl. 725/131; 725/139; 725/151; 725/134; 725/142

(57) ABSTRACT

The present invention provides a system or architecture that integrates a set top box with a digital transmission receiver such as a satellite receiver. The architecture includes a processor that is capable of controlling and operating the components of the satellite receiver while also providing the ability to process interactive content and access the Internet or other network. The architecture provides a unified memory that is used by all the components of the system that require memory. The architecture allows many functions previously performed in hardware to be performed by software. The architecture further ensures that the conditional access is protected and implemented such that consumers are only able to access the channels that they are authorized to access. In addition, the architecture allows for multiple channels to be simultaneously processed to provide additional features and functionality to the consumer.

### BACKGROUND OF THE INVENTION

1. The Field of the Invention

The present invention relates to systems for receiving and processing digital transmissions at a set top box. More particularly, the present invention relates to systems and methods for processing the digital data including interactive content and digital programming content carried by digital satellite transmissions and signals.

2. Background and Related Art

Set top boxes, such as satellite receivers and cable boxes, are common components of home entertainment systems and are typically used to view the programming content that is contained in digital transmissions. In most satellite and cable systems, the set top boxes typically receive digital transmissions from a head end such as a satellite. The digital data included in digital transmissions includes audio data packets, video data packets and data packets. Set top boxes are primarily designed to handle the audio and video data packets, but the architecture of most set top boxes makes this process inefficient. In addition, effectively receiving and processing the data packets is more difficult, especially when the source of the data packets delivered by the satellite and cable systems is the Internet.

In general, most satellite and cable systems are primarily concerned with transmitting the digital transmission or signal from a head end to a destination and with ensuring that the set top boxes that ultimately receive the digital transmission or signal are authorized to decrypt, if necessary, and view the content or programming of the digital transmission. As a result, adding the capability of accessing the Internet or other computer networks, which often provide interactive content, through set top boxes such as satellite receivers and cable boxes has proven both difficult and costly. The general solution has been to simply have two separate set top boxes, where one of the set top boxes is primarily dedicated to processing the interactive content carried in the digital transmission.

The difficulty of accessing the Internet or other computer network through set top boxes such as satellite receivers and cable boxes is evident in the design and architecture of those set top boxes, which have several components that perform specific functions. In the case of the satellite receiver, the digital satellite transmission is initially received by a tuner and a demodulator, which function to select a transport stream within the digital transmission of the satellite system. Next, the transport stream is received by a demultiplexor which effectively filters the transport stream to isolate a channel that contains related audio and video packets. At this point, the satellite receiver determines whether or not the satellite receiver is authorized to decrypt the demultiplexed channel. After the channel has been decrypted, the audio and video components of the channel are decoded to produce video and audio outputs that are interpreted by a user device such as a television. If the channel is not encrypted, then decryption is obviously not necessary and the audio and video components are simply decoded.

As described, a typical satellite receiver includes several separate components. Some of these components require memory to operate and are often controlled or managed by a processor. A significant problem is that each component typically has its own separate memory. In other words, a typical satellite receiver may have physically separate memory chips for each component and each separate memory is only accessible by a particular component. This type of memory arrangement is costly to the consumer and does not use memory effectively. Another significant problem with satellite receivers is that the processors found in typical satellite receivers are not suited for processing interactive content and do not provide adequate browsing capabilities. As a result, using satellite receivers to access the Internet results in a poor user experience.

Another disadvantage of many set top boxes such as satellite receivers and cable boxes is that they each contain multiple processors. One of the processors is typically responsible for managing the demultiplexed channel. The other processor often handles the processing requirements associated with separating a channel from the transport stream. Neither processor is capable of effectively processing the digital data packets and having an extra processor simply increases the cost of the satellite receiver.

An inadequate solution for accessing the Internet is to couple an additional set top box with the satellite receiver. The additional set top box receives the demultiplexed channel into an essentially separate system that has the capability of performing tasks associated with Internet access and processing the digital data or interactive content. While this design may overcome the limitations of the satellite receiver with regard to processing interactive content, other problems are evident. For instance, it is immediately noticeable that the cost of the overall system increases because a consumer will be required to purchase both a satellite receiver and a set top box. In other words, the consumer is effectively purchasing two memories and two processors in the satellite receiver plus an additional processor and memory in the set top box. Thus, the architecture of current set top boxes does not allow for efficiently processing digital transmissions including digital data packets.

### SUMMARY OF THE INVENTION

The present invention relates to an architecture or system that allows the digital data transmitted across digital transmission systems, including satellite and cable systems, to be effectively processed. The systems and methods of the present invention permit a set top box such as a satellite receiver or a cable box to process interactive content and digital audio and video programming such as Moving Pictures Expert Group (MPEG) video and audio. The advantages of the present invention include reduced cost to the consumer and simpler debugging of the digital transmission system when an error occurs. Significantly, the memory of such systems is unified rather than disjointed, which reduces not only the amount of memory required by the set top box, but also the cost of the system. The unified memory may be more efficiently used by the various components of the integrated architecture when processing digital data.

A single processor included in the set top box reduces cost by eliminating one of the processors that have been previously used in prior systems and allows the set top box to process both digital programming content and interactive content. The centralized processor provides control functionality to various components of the set top box. The processor is powerful enough to handle the processing required for digital programming content as well as the processing required for web browsing, interactive content, and multimedia content. The processor is in communication with all components of the set top box that require a processor, and the processor manages a unified memory that is shared among those components of the system that require memory. The unified memory eliminates the need for separate memories and allows the memory to be used more flexibly by the applications and components present on the set top box.

The set top box can be equipped with multiple tuning components, which provides the ability to simultaneously process more than one channel carried by the digital transmission. By processing multiple channels, the user is able to more effectively use the content provided over the digital satellite system. This enables the user to experience additional or advanced functions, such as picture in picture. Finally, the systems of the invention can ensure that the security systems or conditional access systems required by satellite system providers remain intact and are secure.

Many of the functions previously performed by hardware components, such as audio decoding, video decoding, and transport functions, are performed by software in some cases, which further reduces both the necessary hardware components and their associated cost.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates exemplary components of a system used to receive and process digital transmissions;

FIG. 2 illustrates a block diagram of a system for processing digital data carried by a digital transmission that includes a single processor and a unified memory;

FIG. 3 is functional block diagram of a set top box and illustrates the components that permit digital transmissions or signals carrying both programming content and interactive content to be processed; and

FIG. 4 is a detailed block diagram of one embodiment of a set top box architecture capable of processing multiple channels included in a digital transmission.

### DETAILED DESCRIPTION OF THE PREFERRED EMBODIMENTS

As used herein, “interactive content” refers to data or information that is present on or accessed through a computer network such as the Internet and includes, but is not limited to: web pages; Hyper Text Markup Language (html) content; video content and files; graphics such as graphics interchange format (GIF) files and joint photographic experts group (JPEG) files; audio content and files; active server pages; moving pictures experts group (MPEG) audio and video files; web portals; multimedia content, internet sites and the like. Interactive content also refers to the actions that occur between an end user and the Internet or another network including, but not limited to: sending and receiving email; downloading data; uploading data; instant messaging; online purchasing; browsing the web and the like. While the invention is discussed herein with reference to satellite systems and satellite receivers, the systems and methods of the present invention apply in other systems such as cable television systems and cable boxes.

As used herein “digital data” refers to audio, video, and data packets that are transmitted via digital transmission systems including, but not limited to, satellite and cable systems. The data packets often include interactive content as described above, but can also include information related to the encryption and decryption of the audio and video packets. The digital data is not limited to any particular format or standard.

An advantage of digital transmission systems such as a satellite systems is the ability to transfer digital data at high rates of speed. The high rate of speed allows a satellite or digital transmission to carry multiple transport streams, each of which contains a plurality of multiplexed channels. The transport streams include digital data or packets, which are collections of bits intended for a specific purpose and which typically have a common destination.

The strength of a system that uses packets to transmit data or information is that packets that have different purposes or destinations may be multiplexed. Of course, packets that are multiplexed must ultimately be separated by a device receiving the multiplexed packets. The nature of a satellite transmission system is well suited to transmit interactive content in addition to satellite television programming. The interactive content is packetized and multiplexed into the satellite transmission for ultimate use by an end user.

Thus, a satellite system is capable of providing a consumer with access to the Internet or other computer networks and has the advantage of transmitting data at high bit rates. A user has the potential of accessing the Internet much more quickly in comparison to other methods. However, access to the Internet or other computer network is only possible if the set top box or other receiver that receives the satellite transmission can efficiently process the programming content and the interactive content that is transmitted over the satellite system. The present invention provides a system or architecture that permits a set top box to effectively and efficiently process the digital transmission that carries digital data including interactive content, video, and audio data.

The invention is described below by using diagrams to illustrate either the structure or processing of embodiments used to implement the systems and methods of the present invention. Using the diagrams in this manner to present the invention should not be construed as limiting of its scope. The present invention extends to both methods and systems for integrating the functions of a satellite receiver with a system capable of interacting with a computer network such as the Internet. The embodiments of the present invention may comprise a special purpose computer such as a set top box, or a general purpose computer including various computer hardware, as discussed in greater detail below.

Embodiments within the scope of the present invention also include computer-readable media for carrying or having computer-executable instructions or data structures stored thereon. Such computer-readable media can be any available media which can be accessed by a general purpose or special purpose computer. By way of example, and not limitation, such computer-readable media can comprise RAM, ROM, EPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions. As used here in, “set top box” extends to any apparatus or system that performs the functions disclosed herein, including units for use with television sets, units integrated with television sets, general or special purpose computers, and the like.

FIG. 1 is a block diagram generally illustrating the major components of a system or architecture capable of receiving and processing both the digital data provided in or carried by the digital transmissions of satellite systems. An antenna 20, illustrated in FIG. 1 as a satellite dish, receives digital transmissions or signals from a head end or source and transmits the digital transmissions to a set top box 30. The set top box 30 receives the digital transmissions of the satellite system captured by the antenna 20 and processes the digital transmission to produce both video and audio outputs. The video and audio outputs are available to be rendered through a television 22 or another end device that can render the video and/or the audio, which may be a computer monitor.

The set top box 30 includes a system or architecture that provides the functionality and processing power necessary to permit the audio, video and interactive content carried by a digital transmission to be effectively processed. In addition, the set top box 30 does not frustrate the security and protection schemes required by providers of satellite programming content.

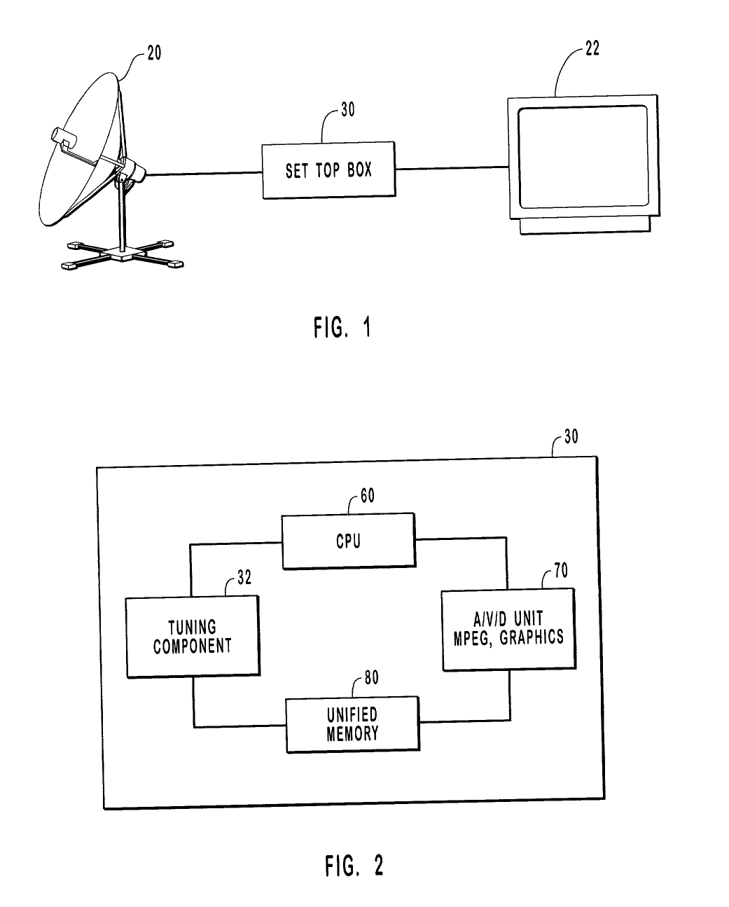

FIG. 2 is a block diagram that illustrates a general architecture of the set top box 30 that receives the digital transmission. The components of the set top box 30 shown in FIG. 2 are a processor or processing component (CPU) 60, a tuning component 32, an audio/video/data (A/V/D) unit 70 and a unified memory 80. The tuning component 32 functions to select a channel from the digital transmission of the satellite system. The selected channel can carry, for example, programming content including related audio and video packets that are rendered as a television program or movie. When the selected channel is programming content, the selected channel may also carry data packets that provide security information that the set top box uses to decrypt the programming content. Alternatively, the selected channel may contain data packets that correspond to interactive content. In this case, the CPU 60 provides browsing functionality such that the interactive content may be used.

The system or architecture as illustrated in FIG. 2 provides significant advantages. The CPU 60 provides processing requirements for the tuning component 32 and the A/V/D unit 70. As previously described, this differs from other set top boxes, which have at least one other processor for the other set top box components. The set top box 30 also provides a unified memory 80 that is able to satisfy the memory requirements of the A/V/D unit 70 and the tuning component 32 effectively. The memory 80 can be used dynamically by the A/V/D unit 70 and the tuning component 32 according to their respective needs. As described, previous set top boxes utilized a separate memory for each set top box component. The CPU 60 manages the unified memory 80 and provides each component of the set top box 30 with access to the unified memory 80. As a result, the unified memory 80 is more efficiently governed by the CPU 60 and less physical memory is needed for the operation of the set top box 30.

Because the set top box 30 includes a single CPU 60 and a unified memory 80, some of the functions of the set top box that were previously performed in hardware can be performed in software. For example, audio and video decoding can be performed in software instead of hardware in some instances. Conditional access functions and transport functions can also be implemented in software. The CPU 60 provides the set top box 30 with browsing capabilities and the A/V/D unit 70 is capable of efficiently processing the interactive content or data packets received through the set top box 30. In some instances, the A/V/D unit 70 provides the browsing capabilities to the set top box 30.

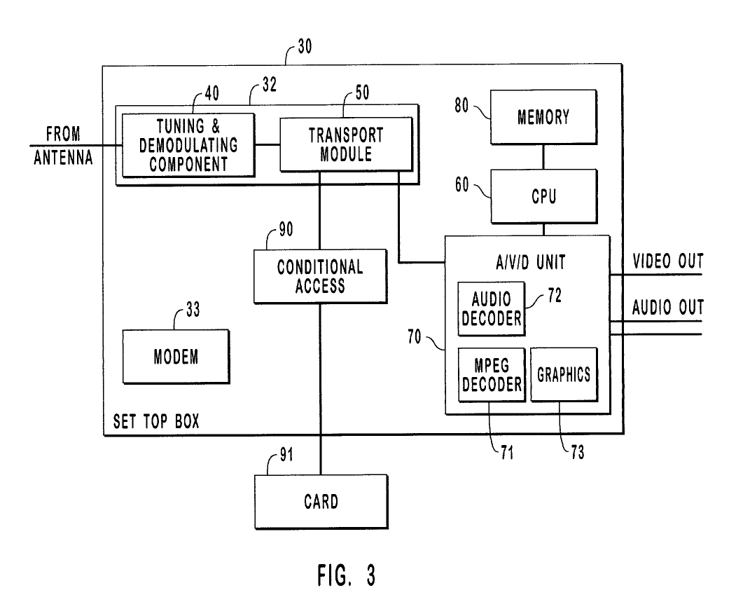

FIG. 3 is a more detailed block diagram of set top box 30 and illustrates a more detailed architecture for the set top box 30. An important and primary function of set top box 30 is to allow an end user to view the programming content carried in the digital transmissions of satellite systems. A second function of set top box 30 is to provide for conditional access such that the providers of the programming content are assured that the programming content is only accessed or viewed by authorized consumers. A third function of the architecture illustrated in FIG. 3 is to provide sufficient resources such that digital data, including interactive content, may be accessed and utilized by an end user of set top box 30.

The function of allowing a user to view programming content begins with the tuning component 32. The input signal or digital transmission of the satellite system received by the tuning component 32 from the antenna illustrated in FIG. 1 is tuned and demodulated to select a particular channel that is carried by the input signal. In this example, the digital transmission is tuned by the tuning and demodulating component 40 to produce a transport stream. The transport stream produced by the tuning and demodulating component 40 has a relatively high bit rate because the transport stream typically includes multiple channels. In other words, the transport stream is typically a multiplexed serial bitstream comprising separate and identifiable packets, each of which is usually associated with a particular channel. The actual number of channels in a particular transport stream is dependent on the quality of each channel. Higher quality channels require more packets and consume more of the available bandwidth.

The tuning component 32 also includes a transport module 50, which provides transport functions for the transport stream that was tuned and modulated by the tuning and modulating component 40. The transport module 50 receives the transport stream, which has a relatively high bit rate, and separates one of the channels contained in the transport stream. By demultiplexing the transport stream, the channel output by transport module 50 is a single channel or a serial bitstream that contains the packets of interest. As a result, the output of transport module 50 has a much lower bit rate than the output of the tuning and demodulating component 40.

The channel output by transport module 50 is frequently an encoded bitstream and may contain MPEG audio and video packets as well as other types of video and audio signals. The channel produced by the transport module 50 is received and decoded by the A/V/D unit 70 in one embodiment, and the A/V/D unit 70 is preferably capable of decoding all necessary types of video and audio packets that are carried by digital transmissions. U.S. Pat. Nos. 5,774,206 and 5,812,791, which are hereby incorporated by reference in their entirety, describe processes for decoding MPEG video and audio and are implemented in one embodiment of the A/V/D unit 70. After decoding the audio and video packets, the A/V/D unit 70 produces video and audio outputs which may be interpreted by a display device. In this manner, the set top box 30 is capable of performing the function of allowing an end user to hear and view the satellite programming content contained in the digital transmission or input signal received by the antenna.

The operation of the tuning and demodulating component 40, the transport module 50, the A/V/D unit 70, and the conditional access 90 frequently requires the assistance of both a processor and memory. The CPU 60, which is representative of a processor or computer as described previously, is capable of providing the necessary control and processing power to the components illustrated in FIG. 3. In addition, the memory 80 is a physically unified memory and provides the necessary memory requirements for the A/V/D unit 70, the transport module 50, the tuning component 32, the conditional access 90, and the CPU 60. Because the memory 80 is unified, it may provide less physical memory than would otherwise be required if each component of the set top box 30 had their own separate memory.

The conditional access 90 is a sub-system or component of set top box 30 that ensures that the programming content of digital transmissions is viewed only by authorized consumers. As previously described, the transport functions of transport module 50 produce a demultiplexed bitstream of related packets. Each packet is typically 188 bytes long and each packet has an identifier. From the identifier, the packet can be identified as a video packet, an audio packet, data packet or another type of packet.

The important packets, with regard to the conditional access 90, are entitlement management message (EMM) packets and entitlement control message (ECM) packets. When an EMM or ECM or other conditional access packet is received, it is sent to the conditional access 90. Typically, the EMM and ECM packets are transmitted to the conditional access 90 after the transport module 50 produces a particular channel, because the EMM and ECM packets are usually related to the particular channel being produced by transport module 50.

The EMM packets inform the set top box 30 which channels or programs the user is allowed to descramble and the ECM packets contain both the title, control messages, and encrypted keys, which are used to decrypt an encrypted channel. The conditional access 90 typically transmits the EMM and ECM packets to a vendor supplied card or other device, which returns the decrypted keys to the conditional access 90. The conditional access 90 receives the decrypted keys, which enables the set top box 30 to decrypt or descramble the channels and other signals to which the user has authorized access. As illustrated, the output channel of the transport module 50 is decrypted by the transport functions provided by the transport module 50 and the A/V/D unit 70 then decodes the decrypted channel to produce the audio and video outputs.

As described, the conditional access 90 typically passes the ECM and EMM packets to an external source, such as a card 91, which has the capability of decrypting the encrypted keys carried by the ECM packets. Thus, the conditional access 90, in this embodiment, may be embodied as a port through which the relevant packets are transmitted to a card 91 or other device. In another embodiment, the conditional access 90 may be embodied as an applications programming interface (API) or other type of software which has the capability of interfacing or communicating with software or hardware provided by the provider of the satellite programming content. After the keys have been decrypted in both these and other embodiments, the conditional access 90 receives the decrypted keys from the card 91 or other vendor system and the set top box 30 is able to use the decrypted keys to unscramble or decrypt the corresponding channel. The conditional access 90 is an example of security means for securing a channel and for ensuring that only authorized consumers obtain access to encrypted channels. The conditional access 90 is also an example of transmission means for providing a vendor system with conditional access packets. The conditional access 90 also receives the information extracted from the conditional access packets by the vendor system. The vendor system can include both software and hardware components. Typically, the conditional access 90 provides the conditional access packets to a software portion of the vendor system. In this manner, the conditional access 90 ensures that the interests of the entities providing the programming content are preserved. While the conditional access 90 has been described in terms of ECM and EMM packets, one of skill in the art will recognize that other types of conditional access packets can be handled in a similar fashion and the systems and methods of the present invention are not limited to ECM and EMM packets. The architecture of the set top box 30 allows packets, including conditional access packets, to be accessed from various components and is not limited to a particular component.

The resources provided by the CPU 60, the A/V/D unit 70 and the unified memory 80 permit the set top box 30 to process digital data including interactive content. More specifically, the A/V/D unit 70 allows the video and audio decoding to be moved from hardware to software, thereby eliminating some of the hardware components that would otherwise be included in the set top box 30 The A/V/D unit 70 is also capable of handling graphics and other interactive content that is either downloaded from or uploaded to the Internet or another network through the set top box 30. The A/V/D unit 70 or the CPU 60 provides a browser that allows access to the Internet and other computer networks. Because interactive content often requires input or other actions from a consumer, the set top box 30 also includes a modem 33 or other suitable device that permits digital data that originates at the set top box 30 to be uploaded or submitted.

In sum, the set top box 30 has a single CPU 60, which results in less cost when compared to a system with more than one processor and also provides for simpler debugging. The CPU 60 and the A/V/D unit 70 also provide the ability to perform some decoding, including audio decoding, in software as well as some of the transport functions performed by the transport module 50. The set top box 30 has a unified memory 80, which eliminates some cost when compared to systems having separate memories. The unified memory 80 allows for memory economy among the components of the set top box 30. The A/V/D unit 70 is a sub-system or component of the set top box 30 that is designed to accommodate interactive content as well as decode the audio and video packets.

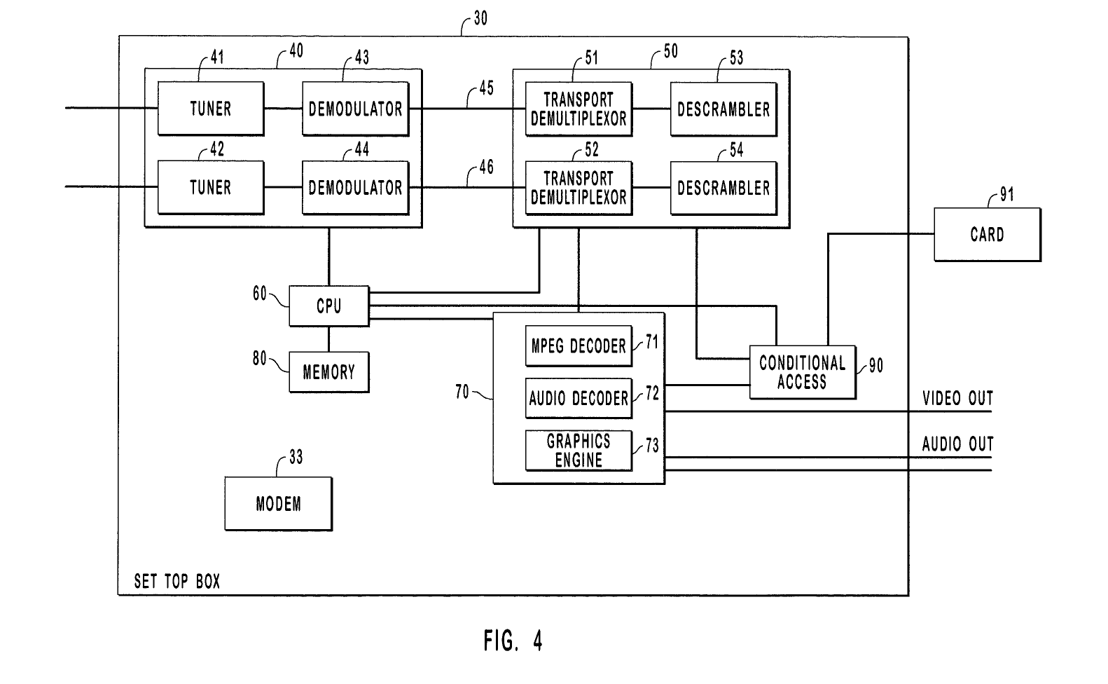

FIG. 4 is a detailed block diagram illustrating one embodiment of a set top box 30, which also serves as a satellite receiver. The tuning and demodulating component 40 of the set top box 30 has a plurality of tuners illustrated as tuner 41 and tuner 42. Providing more than one tuner enables features including but not limited to: picture in picture; recording one channel or signal while viewing a separate channel; and viewing the video of one channel while listening to the audio of another channel. For each tuner 41 and 42 there is a corresponding demodulator in the tuning and demodulating component 40, illustrated as demodulator 43 and demodulator 44. The signal received from an antenna is provided to each set of tuners and demodulators and each tuner and corresponding demodulator produces a tuned and demodulated transport stream.

The output signal or transport stream, as described previously, is typically a serial stream of multiplexed digital data and includes identifiable packets. Because the packets are multiplexed within the serial stream or channel, the next portion or component of the set top box 30 is the transport module 50. The transport module 50, as illustrated, provides a transport demultiplexor 51 for the transport stream 45 and a transport demultiplexor 52 for the transport stream 46. More generally, there is a corresponding transport demultiplexor for each tuner and demodulator set. It may be possible for a single transport module 50 to function for all channels output by the sets of tuners and demodulators. In some instances, the transport module 50 or various functions performed by transport module 50 are embodied in software.

The transport demultiplexors 51 and 52 essentially function as filters to separate or isolate a particular channel from the transport streams 45 and 46. In effect, the transport streams 45 and 46 are demultiplexed by transport demultiplexors 51 and 52. The transport streams 45 and 46 have a high bit rate and the transport demultiplexors 51 and 52 reduce that bit rate significantly by discarding unneeded packets. Typically, the packets or channels output by the transport demultiplexors 51 and 52 are still encoded and are possibly encrypted. If the channel is encrypted, the transport module 50 communicates with the conditional access 90, which passes certain access packets to the card 91. The card 91 generates the decrypted keys, which are then provided through conditional access 90 to the descramblers 53 and 54, which may decrypt the encrypted packets or data as previously described.

In the set top box illustrated in FIG. 4, the conditional access 90 is shown as being evaluated and performed at either the transport module 50 or the A/V/D unit 70. However, because the set top box 30 has a central CPU 60 and the conditional access packets are easily distributed, conditional access 90 can be invoked at other times and places. In other words, set top box 30 has the capability of receiving the conditional access packets into the memory 80. Then, the conditional access packets are passed to the conditional access 90 and the requirement of evaluating whether a consumer may access a particular channel at the transport module 50 is eliminated. The conditional access 90 is preferably implemented in software.

An important aspect of the set top box 30 is CPU 60, which is capable of providing the control and processing requirements of the tuners 41 and 42, the demodulators 43 and 44, the transport demultiplexors 51 and 52, the descramblers 53 and 54, and the A/V/D unit 70. Because the CPU 60 is used by other components of set top box 30, memory 80, which is associated with and controlled by the CPU 60, is economized and more efficiently used. In comparison, previous embodiments of satellite receivers had a separate memory for each component that required memory.

The A/V/D unit 70 is illustrated in FIG. 4 as having MPEG decoder 71, audio decoder 72 and graphics engine 73. The A/V/D unit 70 is also capable, in some embodiments, of performing the transport functions provided by transport module 50. The CPU 60, in combination with A/V/D unit 70, is further capable of handling interactive content as well as providing Internet browsing capability. Thus, set top box 30 is suited for both viewing satellite programming content and effectively accessing a network such as the Internet. The A/V/D unit 70 provides video and audio outputs which are interpreted by another device such as a television.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. In a system that receives a digital transmission, wherein the digital transmission includes digital data including video packets, audio packets and data packets, a set top box for receiving and processing the digital data, the set top box comprising:
a tuning component for receiving the digital transmission, wherein the tuning component produces at least one channel, each at least one channel having digital data;
an A/V/D unit for processing each at least one channel;
a processing component including a browser operably connected with the tuning component and the A/V/D unit, wherein the processing component provides control functionality for the tuning component and the A/V/D unit; and
a unified memory controlled by the processing component, wherein the unified memory satisfies memory requirements of the tuning component, the A/V/D unit, and the processing component.

2. A set top box as defined in claim 1, wherein the tuning component comprises:
at least one tuning and demodulating component for tuning and demodulating the digital transmission to produce at least one transport stream; and
at least one transport module for producing the at least one channel from the at least one transport stream.

3. A set top box as defined in claim 2, wherein the at least one tuning and demodulating component comprises:
at least one tuner, each at least one tuner tuning the digital transmission to the at least one transport stream; and
at least one demodulator for demodulating the at least one transport stream.

4. A set top box as defined in claim 2, wherein the at least one transport module comprises:
at least one transport demultiplexor for demultiplexing each at least one transport stream to produce each at least one channel; and
at least one descrambler for decrypting each at least one channel that is encrypted.

5. A set top box as defined in claim 1, wherein the A/V/D unit comprises:
an audio decoder for decoding audio packets of the at least one channel;
a video decoder for decoding video packets of the at least one channel; and
a data component for processing data packets of the at least one channel.

6. A set top box as defined in claim 1, further comprising a conditional access, wherein the conditional access receives conditional access packets in the at least one channel and transmits the conditional access packets to a vendor system.

7. A set top box as defined in claim 6, wherein the conditional access receives decrypted keys from the vendor device for use in decrypting each of the at least one channel that is encrypted.

8. In a system capable of receiving a digital transmission having digital data including interactive content, video programming and audio programming over a digital system, a set top box for receiving and processing the digital data, the set top box comprising:
one or more tuning and demodulating components for tuning and demodulating one or more transport streams contained in the digital transmission, each transport stream being capable of carrying the digital data;
a transport demultiplexor operably connected to the one or more tuning and demodulating components for demultiplexing each transport stream output by the one or more tuning components to produce one or more channels;
an A/V/D unit for processing the digital data of the one or more channels, wherein the A/V/D unit decodes the video programming and the audio programming and processes the interactive content of the one or more channels;
a unified memory; and
a processing component including a browser that provides the one or more tuning and demodulating components, the transport demultiplexor, and the A/V/D unit with access to the unified memory, wherein the unified memory is dynamically allocated to the one or more tuning and demodulating components, the transport demultiplexor, and the A/V/D unit according to their respective needs.

9. A set top box as defined in claim 8, wherein the interactive content includes one or more of: digital video; digital audio; graphics; and Internet web pages.

10. A set top box as defined in claim 8, wherein each tuning and demodulating component comprises at least one tuner operably connected to at least one demodulator.

11. A set top box as defined in claim 8, wherein each channel is a video stream.

12. A set top box as defined in claim 8, wherein the set top box further comprises a communications device.

13. A set top box as defined in claim 12, wherein the communications device is a modem for connecting with the Internet over the digital system.

14. A set top box as defined in claim 8, wherein the A/V/D unit further comprises:
a graphics engine for processing interactive content of the one or more channels;
an audio decoder for decoding audio packets of the one or more channels; and
a video decoder for decoding video packets of the one or more channels.

15. A set top box as defined in claim 8, further comprising a conditional access component, wherein the conditional access component receives conditional access packets from the digital transmission and transmits the conditional access packets to a vendor system.

16. A set top box as defined in claim 15, wherein the conditional access component receives entitlement management message (EMM) packets and entitlement control message (ECM) packets carried in the digital transmission and provides the ECM packets and the EMM packets to the vendor system.

17. A set top box as defined in claim 16, wherein the conditional access component receives decrypted keys from the vendor system for use in decrypting each of the one or more channels having encrypted digital data.

18. In a system receiving digital transmissions having digital data, the digital data including at least video content, audio content and interactive content, a set top box for processing the digital data, the set top box comprising:
a tuning and demodulating component having a plurality of tuners, each tuner being operably connected with a corresponding demodulator, the tuning and demodulating component producing at least one transport stream from the digital transmission;
a transport demultiplexor for receiving each transport stream output by the tuning and demodulating component, wherein the transport demultiplexor selects a channel from each transport stream, each channel comprising a serial bitstream of related packets, wherein the related packets comprise at least one of: video packets, audio packets, and interactive content packets;
an A/V/D unit including a browser, wherein the A/V/D unit decodes the video packets, decodes the audio packets and processes the interactive content packets with the browser; and
a processor providing a unified memory, wherein memory requirements of the transport demultiplexor, the A/V/D unit, and the tuning and demodulating component are satisfied by the unified memory.

19. A set top box as defined in claim 18, wherein each of the at least one transport streams produced by the tuning and demodulating component comprises multiplexed channels.

20. A set top box as defined in claim 19, wherein the transport demultiplexor demultiplexes each of the at least one transport streams to select at least one channel.

21. A set top box as defined in claim 18, wherein the A/V/D unit is capable of producing at least one video output and at least one audio output for use by an end device.

22. A set top box as defined in claim 21, wherein the end device is a television capable of rendering the at least one video output and the at least one audio output.

23. A set top box as defined in claim 18, wherein the unified memory is accessible by the A/V/D unit, the transport demultiplexor, and the tuning and demodulating component.

24. A set top box as defined in claim 18, further comprising a conditional access component.

25. A set top box as defined in claim 24, wherein the conditional access component comprises security means for ensuring that only authorized consumers obtain access to encrypted channels.

26. A set top box as defined in claim 24, wherein the conditional access component comprises an applications programming interface capable of interacting with a vendor supplied device such that conditional access packets are provided to the vendor supplied device through the conditional access component.

27. In a system having a set top box capable of receiving a digital transmission containing video packets, audio packets, and data packets including interactive content, a method for processing the digital transmission to produce video and audio outputs, the method comprising steps for:
tuning the received digital transmission to produce a transport stream, the transport stream having at least one channel, wherein some of the at least one channel are encrypted;
demultiplexing the transport stream to produce the at least one channel;
passing encrypted keys extracted from the at least one channel, through a conditional access, to a security system;
receiving decrypted keys, through the conditional access, from the security system; and
processing the video packets, audio packets, and data packets contained in the at least one channel with an A/V/D unit to produce the video and audio outputs.

28. A method as defined in claim 27, wherein the step of tuning the received digital transmission further comprises the step of demodulating the received digital transmission.

29. A method as defined in claim 27, wherein the step of passing encrypted keys further comprises the step of transmitting entitlement management message (EMM) and entitlement control message (ECM) packets to the security system.

30. A method as defined in claim 27, wherein the step of processing the video packets, audio packets, and data packets contained in the at least one channel with an A/V/D unit further comprises the steps of:
decoding the audio content;
decoding the video content; and
processing the interactive content with a browser.

31. A method as defined in claim 27, wherein the step of receiving decrypted keys further comprises the step of decrypting the at least one channel if the at least one channel is encrypted.

32. A method as defined in claim 27, wherein the conditional access comprises an applications programming interface, wherein the applications programming interface is accessible by the security system.
